(19) United States
(12) Patent Application Publication
(10) Pub. No.: US 2003/0221183 A1
(43) Pub. Date: Nov. 27, 2003

(54) Virtual friend with special features

(76) Inventor: Petr Hejl, White Rock (CA)

Correspondence Address: Vermette & Co., Granville Square, Suite 230, 200 Granville Street, Box 40, Vancouver, BC, V6C 1S4, CA

(21) Appl. No.: 10/445,230

(22) Filed: May 27, 2003

(30) Foreign Application Priority Data
May 24, 2002 (CA) 2,387,451

(51) Int. Cl. G06F 9/44

(52) U.S. Cl. 717/116

(57) ABSTRACT

Virtual friend is a computer program, which converses with a user as though it were a person, a user's actual friend. At present, there exist a few software programs to create virtual friends. However only simple conversation is possible and virtual friend cannot develop into a real world friend.

The invention defines data structures for more sophisticated conversation. It suggests using actual hidden person behind the virtual friend program, which can interfere into the conversation so that for the user the virtual friend behaves like being a real person. The invention suggests pairing of persons using actual person's properties and desired virtual friend's properties; when desired properties of a virtual friend of a first conversing persons fit with actual properties of second conversing person and desired properties of virtual friend of second conversing persons fit with actual properties of the first conversing person, then such two persons fit each other. Virtual friends can change into actual friends in this way. This invention can create a virtual enemy by replacing the friendly texts with unfriendly texts.

Using these methods virtual friends can be created, having much more human behavior and a virtual friend can become an actual friend.

### FIELD

The present invention relates to a method and programming structure for constructing a virtual friend which converses with a user as though it were that user's actual friend.

### BACKGROUND

There a few software programs in existence that create a virtual friend with whom correspondence is achieved through the Internet or by mobile phone. Simple conversation is possible with such virtual friends but not to a very sophisticated level.

### SUMMARY OF THE INVENTION

1. Object and Property Structure

Objects and properties are defined by new object programming structures: name.index.property

2. Files

A virtual friend is constructed using the files “object classes file”, “virtual friend texts”, “virtual friend conversation recordings”, described below.

3. Clever Conversation

By a hidden person interjecting into the conversation, a virtual friend may behave like an actual friend.

4. Surprise

Using conversation data and comparing actual properties of conversing persons with desired properties of virtual friends, conversing persons with equal or similar properties may be found (paired) and so virtual friends may become actual friends.

5. Virtual Enemy

Using a similar principle as in a “virtual friend”, a “virtual enemy” may be constructed by replacing the friendly texts with unfriendly texts.

### BRIEF DESCRIPTION OF THE DRAWINGS

FIG. 1 is a schematic diagram of a feature defined as “clever conversation”; and

FIG. 2 is a schematic diagram showing the algorithm for using a virtual friend to find an actual friend.

### DETAILED DESCRIPTION WITH REFERENCE TO THE DRAWINGS

1. Object and Property Structures

A virtual friend is a personalized data structure established through the interaction of a general software program with a user. The objects corresponding to a virtual friend may be persons, animals, or other things. These objects may be either general objects (e.g., earth, weather . . . ), or they relate somehow to the conversing person (e.g., brother, ball . . . ). The term properties as used in the following means height, color, etc.

The following basic structure for the description of objects and their properties is used, namely, “name.index.property”. In the foregoing structure the meaning of the alphanumeric words is as follows:

“name” is the name of the object in a single set, e.g. brother, ball;

“index” is the serial number (1, 2, 3 . . . ) of the object within the set;

“property” is the name of particular property used to describe a user, virtual friend or any other object in a conversation. Such property could be words such as height, weight, or color.

This basic structure, when used as computer variable, may contain some value of the object's property such as “180”, “blue”, etc.

Modifications of the basic structure may occur in the following variants (we choose here “brother” as an example of the object):

“brother.defined”—indicates, whether any brother of the conversing person was already mentioned

(defined) during the conversation

“brother.number”—gives the number of brothers of the conversing person

“brother.index”—gives serial number of the brother of the conversing person

“brother.index.defined”—indicates, whether the brother with serial number “index” was already

mentioned (defined) during the conversation

“brother.index.name”—gives the name of the brother with serial number “index”

“brother.index.property.defined”—indicates, whether the value of the property of the brother with

serial number “index” was already mentioned (defined) during the conversation

Usage:

The object and property structures defined above can be used as a variable or as a file item identifier. It can also be used in descriptive text.

Remarks:

The character dot “.” in the structure above may in the program be replaced by underscore “_” or by space “ ”.

The structure defined above differs from the standard object.property structure used, so far, in object programming.

### EXAMPLE

brother.2.height=180 means that the conversing person has two brothers and that the height of the second brother is 180 centimeters.

2. Files

Object Classes

This file is used to generate dialogues about objects.

Each class or set of objects in the file is described using the following items:

superior class plural name: e.g. people, animals, things, UFO, processes, ideas

class singular name: e.g. person, animal, thing, UFO, process, idea

class plural name: e.g. people, animals, things, UFO, processes, ideas

class objects must be defined: existence of objects must be defined in conversation

class objects numbers must be defined: number of objects must defined in conversation

class preference: conversation about this class is to be preferred in dialogue

repeat these fourths:

object singular name: e.g. brother, dog, ball, Martian, weather

object plural name: e.g. brothers, dogs, balls, Martians, weather

object type: characterisation the object or relation(s) between the conversing person and the object, e.g. have, know, like, pursue, believe in, rare, very rare, expensive, very expensive, child, adult, sometimes, nearly always, always

object preference: conversation about this object is to be preferred in dialogue

Virtual Friend Texts

This file is used to define the main stream of conversation.

Each file message between the conversing person and virtual friend has the following structure:

object class plural name: e.g. people, animals, things, UFO, processes, ideas

object name: brother, sister, dog, ball, Martian, weather, dream

object defined index: serial number of the object in the set of objects

object property name: e.g. height, color

message type: e.g. initial, message, question, answer, reaction

message kind: e.g. define, number, value

date and time: to use the message in conversation (e.g. hourly, daily, weekly)

*repeat these triples:

condition: keywords (e.g., good, bad, raining, etc.) or intervals (e.g., 160-180 cm), separated by commas;

text: text to be sent, when preceding message or condition contains the above keyword

next action: identification of the next message in the conversation

Virtual Friend Conversation Recordings

This file consists of the following records, each describing one message, which occurred in the conversation:

date: date, when the message was sent or received

time: time, when the message was sent or received

object-property structure: structure which corresponds to the subject of the message, e.g. brother.1.name

value: value which was sent or received, e.g. Paul

3. Clever Conversation

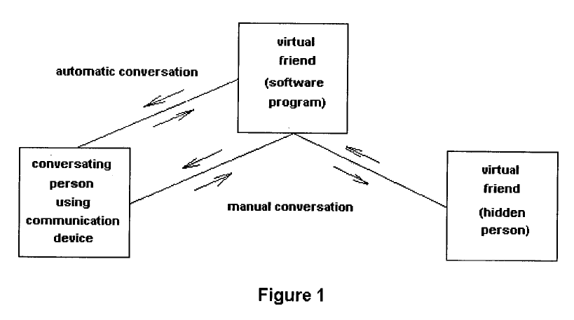

Referring to FIG. 1, the conversation consists of messages (questions, answers, comments . . . ) which are sent by the conversing person to the virtual friend and vice versa. This conversation may be communicated by using text messaging (email, SMS etc.) or in the future perhaps even using voice (recognition and synthesis, phone etc.). Virtual friend is a software program, which runs on a server or computer. To this server many computers may be connected (e.g. via Internet), to which live people are also connected. These people are workers or volunteers in the virtual friend providing company (organisation). These people can intervene in the conversation with the conversing person(s) at an appropriate time. The connected live people have available on their computers (displays) all the information concerning the conversing person and corresponding virtual friend. They can also read or hear the preceding conversation so that they can simply continue this conversation. As these workers or volunteers are internal (company, organisation) persons, they are not visible to the conversing person. So the virtual friend may sometimes behave like an actual friend and the conversing person will have the impression, that the virtual friend is as clever as an actual person. With one conversing person, different internal workers may lead the conversation for each message, or one of the available workers may be assigned to the conversation for an extended duration or for some sequence of messages.

4. Surprise

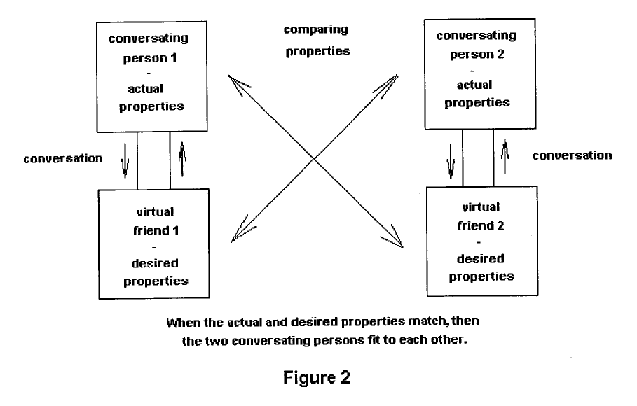

Referring to FIG. 2, the conversing person specifies in the conversation his/her properties and desired properties of the virtual friend (gender, age, height, weight, hair color, hobbies . . . ). By these properties, pairing of people may be accomplished. That is for a conversing person, an actual friend is found who fulfills these properties or criteria. And vice versa for whom the conversing person has the desired properties (of his/her virtual friend). Then the virtual friend system may place both the conversing persons in direct contact with each other (e.g. by giving them the mobile phone numbers). So virtual friend can by surprise change into actual friends. A dream may become a pleasant reality.

5. Virtual Enemy

“Virtual enemy” is also a software program, which can use the first four features stated above. But in contrast to virtual friend, virtual enemy behaves rough and uses strong or even course words in a conversation. This may be humorous for many conversing persons (black humor). A conversing person may also use rough or strong expressions towards the virtual enemy. Rough texts are included in the “virtual friend texts” file.

I claim:

1. A method of forming virtual friends, comprising:
(a) establishing file structures “object classes” and “virtual friend texts” to generate conversation
(b) establishing data structures in the form of “name.index.property” and file structure “virtual friend conversation recordings” for a user; and
(c) deriving a conversation structure from said file structures and from values of said data structures

2. A method according to claim 1, including:
(a) forming a virtual friend of a user;
(b) manually intervening by a third party, in response to a question from said user to said virtual friend, to permit said third party to control the conversation with said user

3. A method according to claim 1, including:
(a) a first user having a first characteristic and desiring a second characteristic in a friend forming a first virtual friend having a second characteristic;
(b) a second user having a second characteristic and desiring a first characteristic forming a second virtual friend having the first characteristic; and
(c) searching through data structures of users and virtual friends, for said first virtual friend, to locate a user with an identical second characteristic and having a virtual friend with an identical first characteristic.

4. A method according to claim 1, to construct virtual enemy by replacing the file “virtual friend texts” by the file “virtual enemy texts”, where rough and strong words are used.
